(19) United States
(12) Patent Application Publication
(10) Pub. No.: US 2022/0394952 A1
(43) Pub. Date: Dec. 15, 2022

(54) Multi-Pet Feeding Station

(71) Applicant: Joseph Strauss, Birdsboro, PA (US)

(72) Inventor: Joseph Strauss, Birdsboro, PA (US)

(21) Appl. No.: 17/520,910

(22) Filed: Nov. 8, 2021

Related U.S. Application Data
(60) Provisional application No. 63/208,553, filed on Jun. 9, 2021.

(51) Int. Cl. A01K 5/01

(52) U.S. Cl. CPC A01K 5/0142

(57) ABSTRACT

The present invention relates to a multiple pet feeding station. The feeding station is a multi-tiered feeding system for homes with multiple pets and uses multiple tiered spaces or shelves for storing pet food, accessories and water dishes. A plurality of feeding trays with feeding bowls allow the food to be placed at different heights to prevent one pet from eating the food of the other. The feeding trays are adjustable and removable allowing a user to adjust the tray vertically to accommodate pets of various sizes. As an example, a cat's dishes can be kept in feeding bowls at a higher height than a dog's dishes to ensure the dog does not eat the cat's food while allowing the pets to simultaneously be fed.

### CROSS-REFERENCE TO RELATED APPLICATION

The present application claims priority to, and the benefit of, U.S. Provisional Application No. 63/208,553, which was filed on Jun. 9, 2021, and is incorporated herein by reference in its entirety.

### FIELD OF THE INVENTION

The present invention relates generally to the field of pet accessories. More specifically, the present invention relates to a multi-functional food, storage and feeding system. The feeding system provides multiple tiered and segregated spaces for storing pet food, other supplies and water dishes, thereby allowing the food to be placed in feeding bowls at different heights to prevent cross-contamination and allowing multiple animals to eat at the same time. The system includes multiple shelves, cubbies and other areas to store pet food containers, pet supplements, medicines and other grooming supplies for keeping all pet-related components in a singular location for easy access during feeding time or when engaging in pet-related activities. The system includes adjustable feeding trays having feeding bowls or containers that can be adjusted vertically to accommodate pets of various breeds, species and heights. Accordingly, the present disclosure makes specific reference thereto. Nonetheless, it is to be appreciated that aspects of the present invention are also equally applicable to other like applications, devices and methods of manufacture.

### BACKGROUND

In general, many people like to have pets and keep pets in their homes. Some people like having dogs of various breeds, other like having cats and many pet enthusiasts have both cats and dogs of a variety of breeds in their home. The task of feeding pets may present problems, such as one pet may try and eat the food of the other. Many pet owners are familiar with the fact that a pet's food may attract ants or other crawling insects and consumption of such food may be unhealthy and distasteful for a pet. Also, quite often in homes with multiple pets, cats, dogs, and other pets eat the food and drink out of the same water bowls. Generally, at mealtimes such as dinner, breakfast or lunch, all the pets simultaneously try to eat and drink. Due to this, cross-contamination can occur between different types of pet food and if one pet is being treated for a condition or disease, the other pets sharing the bowls or containers may become infected with the disease or react to the medication the other pet is receiving. In addition to cross-contamination, this also leads to tipping and spilling of meal and water bowls that create mealtime messiness as well as not ensuring that each pet receives the food or medication intended for that particular pet.

In some cases, bigger breeds such as a Great Dane or other dogs or cats which may be more aggressive may not allow other animals in the home to eat food and drink water and therefore, the other pets may just choose to go hungry, ignoring the food bowl altogether, leaving the owner to wonder if the pets have received their nutritional requirements. To ensure the proper amount feed for their pets, pet owners usually try to create separate feeding areas for different types of pets, however, finding enough space to have multiple feeding areas in homes, particularly where available space is limited, is difficult and may be nearly impossible. Due to lack of space, the pet owners may end up placing meal and water bowls for pets in positions that may be uncomfortable for pets and can cause strain on the pet's neck, back, and joints. Alternatively, pet owners may place food dishes on countertops, tables or other raised areas which is generally unsanitary as the pets have to eat in the same places as their owners are preparing food and eating. Also, presently available pet feeding stations are fixed and can be used for a specific type or size of a pet. Therefore, people end up buying multiple feeding utensils, or stations for their pets.

Even in the presence of a pet owner, preventing pets from eating food and water bowl from others' is difficult and maintaining nourishment and treatment regimens of the pets may prove both physically and mentally taxing on the owner. For example, older pets have different dietary needs than younger pets, overweight pets require different food than pets which are active so maintaining different areas for feeding different pets is important for the health of the animals.

Therefore, there exists a long felt need in the art for a pet feeding station that provides appropriate places for storing pet food, dietary supplements, medicine, grooming and other accessories and water dishes and can be used by multiple dogs, cats, and other pets. There is also a long felt need in the art for a pet feeding station that eliminates the chances of pets eating each other's food. Additionally, there is a long felt need in the art for a pet feeding station that eliminates cross contamination of the food. Moreover, there is a long felt need in the art for a pet feeding station that provides a singular location for easy access of food for pets during feeding time. Furthermore, there is a long felt need in the art for a pet feeding station that can be adjusted to accommodate pets of different sizes and types. Finally, there is a long felt need in the art for a pet feeding station that provides a comprehensive, multi-tiered, and adjustable pet food storage for easy and secure access by a variety of pets.

The subject matter disclosed and claimed herein, in one embodiment thereof, comprises a multiple pet feeding station. The station features a first shelf or section enclosed by a top surface, a bottom surface, a first wall and a second wall. A second shelf or section is positioned adjacent to the first shelf and enclosed by the second wall, a third wall and corresponding top surface. A pair of steps is provided adjacent to the second shelf and are used by a pet for reaching the top surface of the first shelf and the second shelf. A first feeding tray has a pair of feeding bowls that are positioned in the first shelf and attached between the first wall and the second wall. The first feeding tray is vertically adjustable along the height of the first wall and the second wall. The second shelf is used for storing a pet food container. The top surface and the second top surface are used for placing pet food containers and a second feeding tray having a pair of feeding bowls such that the second feeding tray is at a different height than of the first feeding tray.

In this manner, the pet feeding station of the present invention accomplishes all of the forgoing objectives and provides users with a singular location for storing food for a plurality of pets and other items for caring for the pets. The shelves and storage spaces can be adjusted as needed to accommodate different sizes of pets allowing the food to be placed at different heights to prevent cross contamination and from one pet eating the food of the other pet. The feeding station also has steps for reaching food stored at higher height. Finally, the station offers a simple feeding system for homes with multiple dogs, cats, and other pets.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a multiple pet feeding station. The multiple pet feeding station is designed for keeping food and other pet needs for a plurality of pets in a singular location for easy access during feeding time or when tending to the needs of the pet. The station further includes a first shelf enclosed by a top surface, a bottom surface, a first wall and a second wall. The second shelf is positioned adjacent to the first shelf and enclosed by the second wall, a third wall and a second top surface. A set of steps is provided adjacent to the second shelf and are used by a pet for reaching the top surface of the first shelf and the second shelf. A first feeding tray which has a pair of feeding bowls positioned in the first shelf and attached between the first wall and the second wall. The first feeding tray is vertically adjustable along the height of the first wall and the second wall. The second shelf is used for storing a pet food container. The top surface and the second top surface are used for placing pet food containers. A second feeding tray with a pair of feeding bowls is disposed such that the second feeding tray is at a different height than of the first feeding tray.

In yet another embodiment, the top surface is higher than the second top surface or alternatively, the top surface and the second top surface are at the same height. In yet another embodiment, a plurality of additional feeding trays can be removably-placed on the top surface of the feeding station for providing additional options of caring for the pets.

In accordance with another feature of the present invention, both the first wall and the second wall have a plurality of slots for receiving the first tray enabling a user to adjust and fix the tray in one of the slots for a desired height.

In yet another embodiment of the present invention, a pet feeding and care station is disclosed. The pet feeding and care station is used for providing discrete feeding places for a plurality of pets and for storing multiple pet food and other items. The station includes a plurality of shelves for storing pet food containers, a plurality of pet feeding trays in which each of the trays include may hold a plurality of feeding bowls for providing food and other items to the pets. The plurality of pet feeding trays may be placed at different heights such that the pets do not eat from each other's bowls.

In yet another embodiment of the present invention, the feeding bowls for a cat's or other small animal dishes are kept at a higher height than feeding bowls for a dog's or larger animal dishes and thus preventing the dog from eating the cat's food.

In yet another embodiment, a pet feeding apparatus for feeding both larger dogs and shorter dogs is disclosed. The apparatus includes an elongated section having a first plurality of feeding bowls, a shorter section having a second plurality of feeding bowls wherein the first plurality of feeding bowls is positioned at a greater height than the second plurality of feeding bowls. The first plurality of feeding bowls is used for feeding larger dogs (e.g., a Great Dane) and the second plurality of feeding bowls is used for feeding shorter or smaller dogs or pets. The second plurality of feeding bowls cannot be accessed by the larger dogs due to the relatively small bowl size of the second plurality of feeding bowls. Other guards may also be used to prevent the larger animals from reaching the upper bowls, such as retractable netting or weight sensors which may sound an alarm when a larger animal puts pressure on the upper feeding location.

In yet another embodiment of the present invention, the longer section is used for larger dogs and the shorter section is used for cats. In yet another embodiment, the station can be made from one or more of wood, metal, plastic, high density poly ethylene (HDPE) or the like.

An advantage of the present pet feeding apparatus is that the apparatus is a singular device for feeding and storing pet food and is free standing and allows a pet owner to provide food and/or water to multiple pets with minimal effort. Another advantage of the present pet feeding apparatus is that the present device may be easily positioned in minimal space and prevents cross-contamination between pets by preventing them from eating food of each other.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a multiple pet feeding station of the present invention in accordance with the disclosed architecture;

FIG. 2 illustrates a top perspective view of one potential embodiment of the multiple pet feeding station of the present invention in accordance with the disclosed architecture;

FIG. 3 illustrates a perspective view of another potential embodiment of the multiple pet feeding station of the present invention in accordance with the disclosed architecture;

FIG. 4 illustrates a perspective view of yet another potential embodiment of the multiple pet feeding station of the present invention in accordance with the disclosed architecture; and

FIG. 5 illustrates a perspective view showing a dog and a cat eating simultaneously from one potential embodiment of the multiple pet feeding station of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a pet feeding station that provides appropriate places for storing pet food, other pet accessories, and water dishes and can be used by multiple dogs, cats, and other pets. There is also a long felt need in the art for a pet feeding station that reduces the chances of pets eating each other's food and getting things that are intended for one animal and not the other. Additionally, there is a long felt need in the art for a pet feeding station that eliminates cross contamination in the respective food dishes of each of the pets. Moreover, there is a long felt need in the art for a pet feeding station that provides a singular location for easy access of food for pets during feeding time. Furthermore, there is a long felt need in the art for a pet feeding station that can be adjusted to accommodate pets of different sizes. Finally, there is a long felt need in the art for a pet feeding station that provides a comprehensive, multi-tiered, and adjustable pet food storage for easy and secure access by a variety of pets.

The present invention, in one exemplary embodiment, is a novel pet feeding apparatus. The pet feeding station is used for feeding both larger dogs and shorter dogs without any cross contamination and also for storing pet food containers and other pet accessories, such as grooming equipment, toys, supplements, medicine, clothing and other items. The apparatus includes a longer section having a first plurality of feeding bowls for larger dogs, a shorter section having a second plurality of feeding bowls for shorter dogs such that the first plurality of feeding bowls is positioned at a greater height than the second plurality of feeding bowls. The second plurality of feeding bowls cannot be accessed by the larger dogs due to small bowl size of the second plurality of feeding bowls

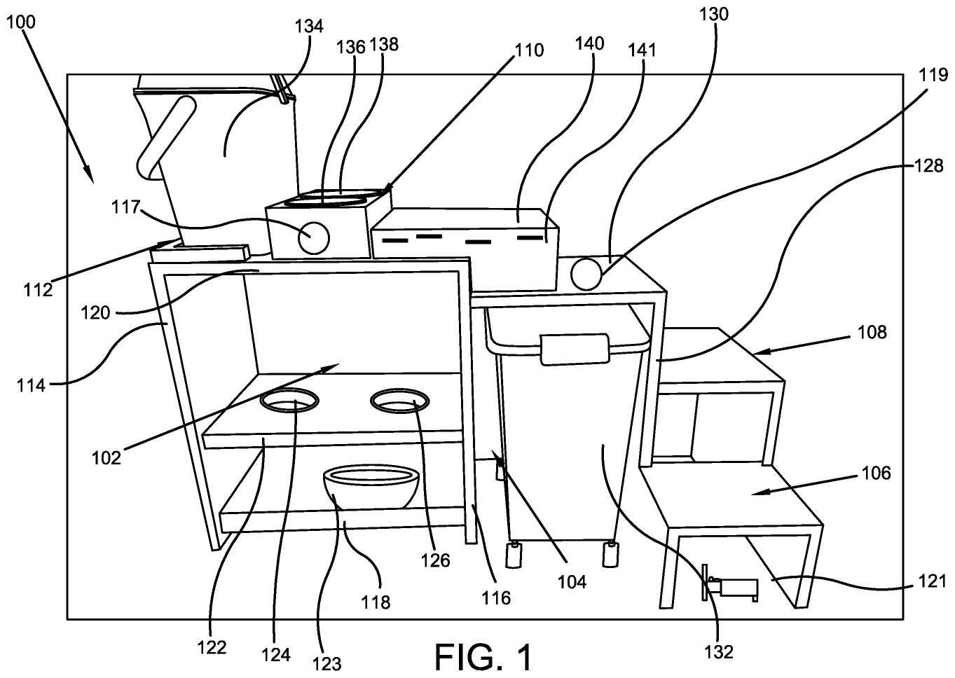

Referring initially to the drawings, FIG. 1 illustrates a front perspective view of one potential embodiment of a multiple pet feeding station 100 of the present invention in accordance with the disclosed specification. The multiple pet feeding station 100 of the present invention is designed as a multi-functional food and feeding system that has multiple tiered spaces for storing pet food, other items and water dishes. The feeding station 100 provides a plurality of shelves that can be adjusted to accommodate pets of different sizes. More specifically in the present embodiment, the feeding station 100 is a portable station in the form of a furniture that has a first shelf or section 102 for accommodating a first or lower feeding tray 122, a second shelf or section 104 for storing pet food and/or water dishes of the pet, a set of steps 106, 108 for a pet to reach a top or second feeding tray 110. The station 100 also has a top slot 112 for storing an additional container containing the pet food and/or water dishes. The first shelf 102 is defined by a first vertical wall 114, a second vertical wall 116, a base 118 and a top surface 120. The lower feeding tray 122 is adjustably fixed to the walls 114, 116 such that the lower feeding tray 122 can be adjusted vertically along the length of the walls 114, 116 to accommodate pets of different heights. The lower feeding tray 122 has a first feeding bowl 124 and a second feeding bowl 126 for storing pet food, other pet accessories and water dishes. The bowls 124, 126 can be filled with a pet feed and the height of the lower feeding tray 122 can be adjusted by a user to accommodate the size of the particular dog or other pet. The lower feeding tray 122 can be formed as a single piece from hard plastic, metal or any other similar material and is secured to the walls 114, 116 using fastening elements such as pins, nuts, and bolts. The feedings bowls 124, 126 can be made from, but is not limited to, food grade plastic or metal.

The second shelf 104 is defined by the second wall 116, a third vertical wall 128 and a top surface 130. The second shelf 104 is preferably used for storing one or more containers shown as an exemplary first container 132. It should be noted that the first shelf 102 and the second shelf 104 are adjacent to each other and have the common second wall 116. Further, the steps 106, 108 are attached to the third vertical wall 128 and can be used as ladder steps or stairs by the pet. The top surface 120 of the first shelf 102 houses the top slot 112 for storing one or more containers shown as exemplary second container 134. The first container 132 and the second container 134 can be of any shape and size and preferably do not form a part of structure of the pet feeding station 100. The top feeding tray 110 is positioned on the top surface 120 of the first shelf 102 and has a pair of feeding bowls 136, 138. The feeding bowls 136, 138 can be used for any pet that reaches the top surface 120 using the steps 106, 108.

For supporting a pet on the top surface 130 of the second shelf 104 and the top surface 120 of the first shelf 102, a L-shape supporting bar 140 is placed partially on the first shelf's top surface 120 and partially on the second shelf's top surface 130. The L-shape bar 140 is removably placed and can be removed as per the preferences of a pet owner. The L-shaped bar 140 may be openable along a line 141 to reveal an additional storage compartment.

The pet feeding station 100 provides a plurality of feeding bowls at different heights allowing multiple pets to get their feed simultaneously. The bowls 124, 126, 136, 138 are removable and are perfect for treats, water, supplements, medicants, or food, and are easy to clean and fill. The food bowls are positioned to reduce the strain on pets' neck, back and joints. Preferably, the size of the bowls 136, 138 on the top feeding tray 110 is used for cats and small dogs and the size of the bowls 124,126 on the lower feeding tray 122 is useful for large dogs and other pets. The top feeding station 110 may also be provided with a first weight sensor 117 to detect if the larger animal jumps up on the top feeding station 110 to remove the food. A second sensor 119 may be provided on the stair on the way up to the feeding dish in the event the larger animal decides to move up the stairs. The sensor may trigger an audible alarm, lights or other alarm to make sure the larger animal is warned away from the upper food station 110. A cat bed 121 may also be provided under one or more of the steps. Storage areas may be created for additional bowls 123 or other animal related accessories.

Preferably, the dimensions of the pet feeding station 100 are 4′ (W)×2′ (L)×3′ (H). Alternatively, the dimensions of the pet feeding station 100 can be 3.5′ (W)×1.75′ (L)×2.75′ (H) or 3′ (W)×1.5′ (L)×2.5′ (H).

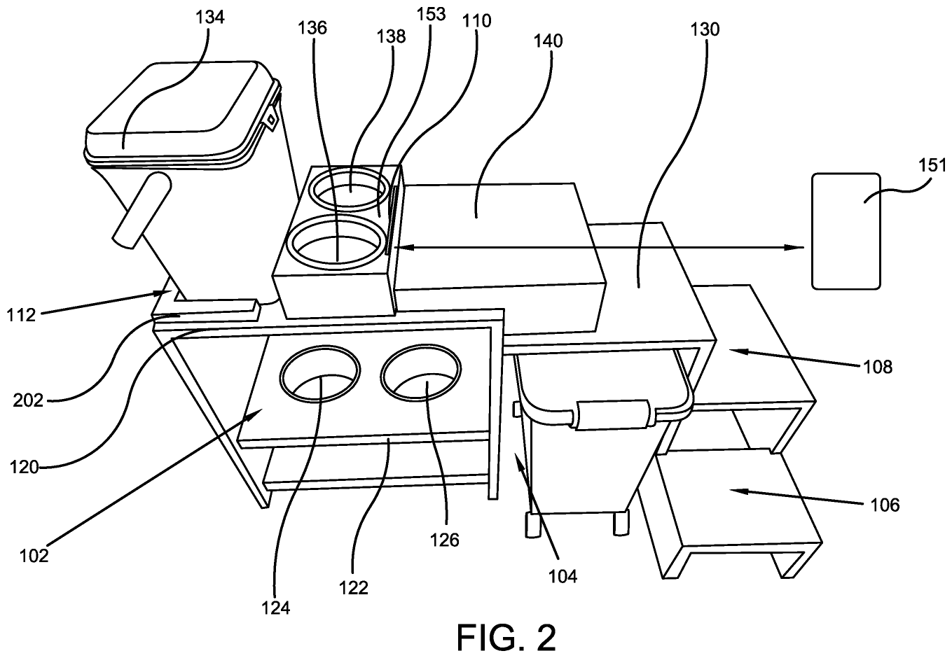

FIG. 2 illustrates a top perspective view of the first potential embodiment of the multiple pet feed station 100 shown in FIG. 1 in accordance with the disclosed specification. At the top of the station 100, the top surface 120 of the first shelf 102 has the top slot 112 surrounded by boundary 202 for the second container 134. The top surface 120 also has the top feeding tray 110 that has smaller food bowls 136, 138. The top feeding tray 110 is detachably attached to the top surface 120 so that the position of the tray 110 can be changed as per preferences of the pet owner or to accommodate different animal stages or sizes say for example a puppy to a full-grown dog. The second shelf's top surface 130 and the first shelf's top surface 120 has the L-shape supporting bar 140 which can be used for additional storage. The bowls 124, 126 of the lower tray 122 can be used for dogs and other animals who can't climb on the steps 106, 108.

The pet feeding station 100 is a single integrated unit with detachable top tray 110 and detachable L-shape supporting bar 140. The lower step 106 can also be detachable in some embodiments allowing a user to detach for easy portability of the station 100 during movement from one place to the other. The feeding and water dishes can also include a sensor element 153 connected to a smart phone 151 with a previously downloaded application to allow the pet owner to be aware of when the bowls are empty and need refilling or that the pets have completed eating their meal.

The pets can be trained to eat food in their respective bowls that are kept at different heights. By positioning the food bowls at different levels, animals that are height challenged are then unable to eat from others' bowls and thus cross contamination is prevented. Further, smaller pets are not deprived of their food by bigger pets using the station 100 of the present invention. Pet owners do not have to keep the pet food for different pets at various places around the home and the food can be stored in one or more shelves and slots of the station 100. Further, multiple treats and dishes can be provided for multiple pets simultaneously. As an example, a cat's dishes can be kept at a higher height on the station than a dog's dishes to ensure the dog does not eat the cat's food.

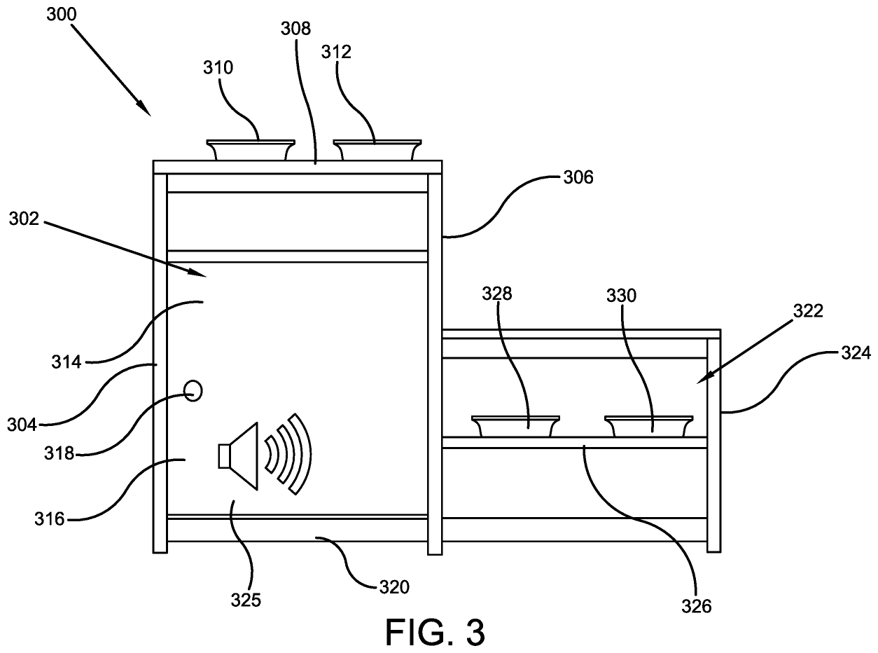

FIG. 3 illustrates a perspective view of a second potential embodiment of the multiple pet feeding station 100 of the present invention in accordance with the disclosed specification. In the present embodiment, the pet feeding station 300 is specifically designed for different breeds of dogs along with other pets. The pet feeding station 300 has a longer section 302 defined by a first wall 304 and a second wall 306. A top surface 308 of the longer section 302 has a pair of larger feeding bowls; a first bowl 310 and a second bowl 312. The height of the higher section 302 is preferably in the range between three feet and six feet without about four to five feet being preferred. A storage space 314 is positioned in the longer/higher section 302 for storing pet food material and is secured by a door 316 that can be opened by a pet owner using the knob 318 for accessing the stored pet food material. The door 316 is hingedly coupled along the second wall 306 for pivotal movement of the door 316. Any container stored in the storage space 314 is placed on the base 320 of the higher section 302. The cabinet 320 may also include a speaker 325 by which a pet owner can play music or issue commands to his or her pets. The speaker 325 can be connected to a smart phone 151 (see FIG. 2) to play the music or commands as needed. The speaker 325 can also be used to issue the audible alarms from the weight sensors if the larger animal jumps up on the platform to eat the smaller animal's food or moves up the set of stairs.

For shorter pets such as cats and other dogs, the station 300 has an integrated shorter section 322 that is positioned and integrated adjacent to the longer section 302. The shorter section 322 is defined by a portion of the second wall 306 and a third wall 324. A vertically adjustable feeding tray 326 is positioned between the second wall 306 and the third wall 324 that has two small feeding bowls 328, 330. The feeding bowls 328, 330 are used by shorter or smaller pets for eating and drinking. The advantage of the station 300 of the present embodiment is that food of smaller pets is not eaten by the larger pets as the bigger bowls 328, 330 are easily accessible to them. Further, for preventing cross-contamination, the smaller pets cannot reach the larger feeding bowls 328, 330 since steps to climb on the surface 326 are not provided in the station 300 and the feeding bowls 328 and 330 are not easily reached by the smaller animals.

The feeding bowls of various embodiments of the present invention are rust-resistant and dishwasher-safe. The bowls have a non-slip base and is ideal for any pet who rushes through mealtime. The station 100 can be made from wood, durable plastic, high density poly ethylene (HDPE) or any other similar materials. Further, the station 100 can be easily wiped down for an effortless cleanup by pet owners.

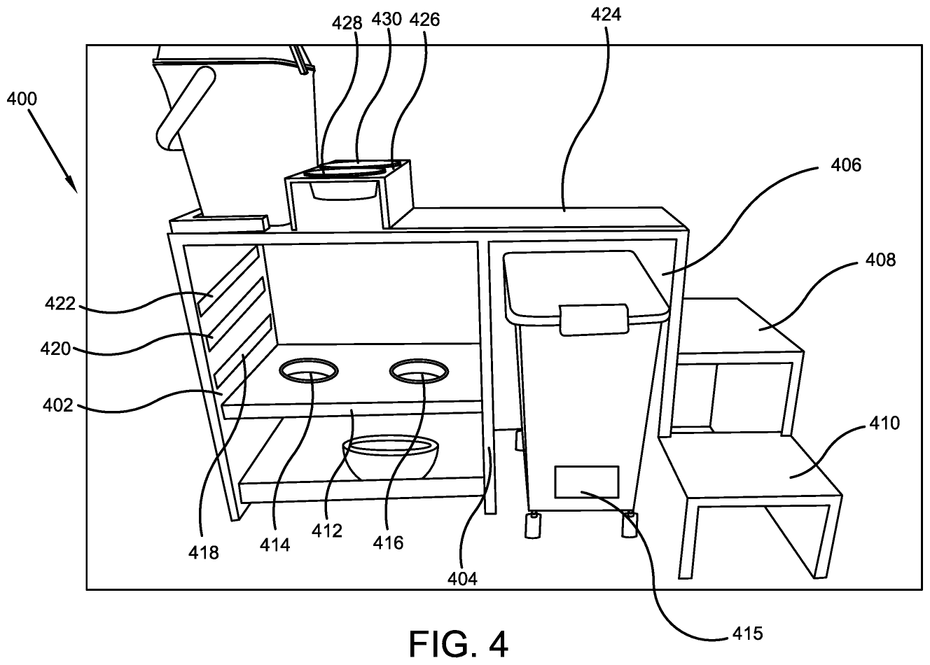

FIG. 4 illustrates a perspective view of third potential embodiment of the multi pet feeding station 400 of the present invention in accordance with the disclosed specification. In the present embodiment, for adjusting the lower tray 412 mounted to the first wall 402 and the second wall 404, a plurality of slots 418, 420, 422 are provided on both the first wall 402 and the second wall 404. The slots 418, 420, 422 are used for adjusting the height of the lower tray 412 along the walls 402, 404 to accommodate pets of different heights. The lower tray 412 has two bowls 414, 416 that are used for storing food and water dishes for the pets. For smaller pets that can climb, a set of steps 408, 410 are provided and attached to the third wall 406. The height of all the three walls 402, 404, 406 are equal and top surface 424 can be used for placing an additional food tray 426 having food bowls 428, 430 for other pets. The top surface 424 can be used for placing food containers thus eliminating the need for a pet owner to store food items at multiple places. The food station may also include smart food storage container which include a RF sensor 415 which can signal to the pet owner that the food supply in the container is getting low or is empty altering the owner that it is time to get additional food for the pets. The smart containers are also connected to the smart phone referenced in FIG. 2.

It is within the scope of this invention for feeding trays to have openings bordering a compartment for receiving including, but not limited to, a removable feeding bowl. An item includes, but is not limited to, food, a liquid, medicine, or dinnerware can be placed in the feeding bowl.

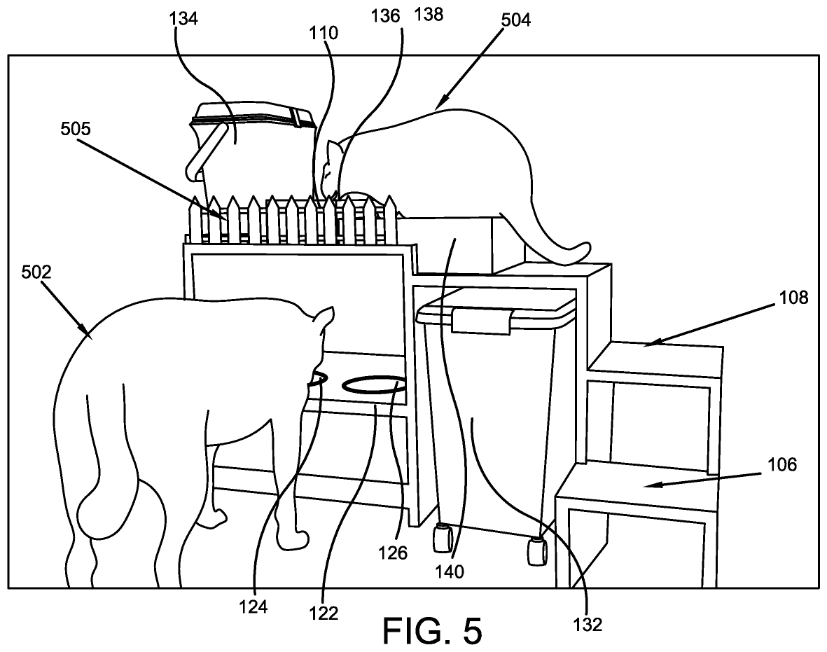

FIG. 5 illustrates a perspective view showing a dog and a cat eating simultaneously on the feeding station 100 of the present invention in accordance with the disclosed specification. Different types of pet materials can be stored in pet food containers 132, 134 placed in the space provided by the station 100 and the pet food containers can be smart containers as discussed in connection with FIG. 4. This eliminates the need for a pet owner to keep containers at different places. As shown, a dog 502 can have the food from the food bowls 124, 126 placed in the lower tray 122 and a cat 504 can have the food from the food bowls 136, 138 placed in the top tray 110. The cat 504 can reach the food bowls 136, 138 using the steps 106, 108 and can sit on the L-shaped supporting bar 140 while having the food. It should be appreciated that the both the dog 502 and the cat 504 can have the food independently by placing the food at different heights. In order to prevent the dog from jumping up to eat the cat food, a retractable and/or removable fence or netting 505 can be added along a side edge of the eating platform to protect the food from being eaten.

In some embodiments of the present invention, a pet can access the pet food bowls only from the front of the station and alternatively, in other embodiments, the pet food bowls can be accessed from both front and back of the station. Using the slots, the trays can be stopped at intermediate positions along the walls to suit pets with various feeding heights. The station of various embodiments permits receiving pet bowls of various sizes for fulfilling needs of a variety of pets.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multiple pets feeding station”, “pet feeding station”, “feeding station”, “station”, and “pet feeding apparatus” are interchangeable and refer to the multiple pets feeding station 100, 300, 400 of the present invention.

Notwithstanding the forgoing, the multiple pets feeding station 100,300,400 of the present invention can be of any suitable size and configuration as is known in the art without affecting the overall concept of the invention, provided that it accomplishes the above stated objectives. One of ordinary skill in the art will appreciate that the size, configuration, and material of the multiple pets feeding station 100, 300, 400 as shown in the FIGS. are for illustrative purposes only, and that many other sizes and shapes of the multiple pets feeding station 100, 300, 400 are well within the scope of the present disclosure. Although the dimensions of the multiple pets feeding station 100, 300, 400 are important design parameters for user convenience, the multiple pets feeding station 100, 300, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A feeding station for feeding a multitude of pets, the feeding station comprising:
a first feeding area at a first level;
a second feeding area at a second level, wherein the second level is distinct from the first level;
a storage area for storing one of a food or a pet related accessory; and
a set of stairs for reaching one of the first or second feeding areas, wherein each of the first and second feeding areas comprise a recess for holding a first bowl and a second bowl, and further wherein each of the first and second feeding areas is sized and configured for feeding animals of different sizes.

2. The feeding station as recited in claim 1, wherein the second feeding area is a level higher in height than the first feeding area.

3. The feeding station as recited in claim 1, wherein the second feeding area is comprised of at least one sensor to detect a weight of a pet on the second feeding area.

4. The feeding station as recited in claim 3, wherein the at least one sensor is connected to an alarm that is one of an audible alarm or a visual arm.

5. The feeding station as recited in claim 1, wherein the set of stairs leads to the second feeding area which is at a greater height than the first feeding station.

6. The feeding station as recited in claim 5, wherein the set of stairs comprises a sensor for detecting a weight of an animal on the set of stairs.

7. The feeding station as recited in claim 5, wherein the second feeding area is comprised of one of a retractable or removable net or a fencing to protect the second feeding area.

8. The feeding station as recited in claim 1, wherein the second feeding area is comprised of an L-shaped platform which fits over a portion of the set of stairs.

9. The feeding station as recited in claim 8, wherein the L-shaped platform is comprised of a compartment contained within the L shaped platform for holding the animal accessory.

10. The feeding station as recited in claim 1, wherein the storage area comprises at least one smart food storage container.

11. A pet feeding station system for feeding a multitude of pets, the feeding station comprising:
a pet feeding station having multiple feeding areas;
at least a first sensor connected to a smartphone;
a storage area for holding at least one of a food, an accessory, a supplement, a medication or a toy;
a set of stairs for reaching at least one of the multiple feeding areas;
at least one of the multiple feeding areas being adjustable; and
a feeding platform positioned adjacent to at least one of the multiple feeding areas.

12. The pet feeding station system as recited in claim 11, wherein the at least one sensor is a weight sensor capable of triggering an alarm.

13. The pet feeding station system as recited in claim 12, wherein the alarm is one of an audible alarm or a visual alarm.

14. The pet feeding station system as recited in claim 11, wherein the multiple feeding areas comprise a first feeding area and a second feeding area, and further wherein the second feeding areas is at a height that is greater than the first feeding area and the set of stairs leads to the second feeding area.

15. The pet feeding station system as recited in claim 11, wherein the storage area comprises at least one smart container having a sensor for communicating with the smartphone regarding a level of food in the at least one smart container.

16. The pet feeding station system as recited in claim 11, wherein a second sensor is connected to at least one of the multiple feeding areas and is used to detect a presence or an absence of a food or a water, and further wherein the second sensor is in communication with the smartphone.

17. The pet feeding station system as recited in claim 11, wherein the storage area comprises a speaker in communication with the smartphone for playing one of a commands, a music or an alarm.

18. The pet feeding station system as recited in claim 11, wherein at least one of the multiple feeding areas is comprised of a removable or retractable gate.

19. A multiple pet feeding platform comprising:
a first feeding level being sized, configured and adjustable to accommodate a multitude of different sized pets;
a second feeding level, wherein the second feeding level is at a height greater than the first feeding level;
a storage area for holding at least one of a pet food, a pet accessory, a pet supplement, a pet medication or a pet toy;
a set of stairs for allowing a pet to access the second feeding level; and
an L-shaped platform positioned adjacent to the second feeding level.

20. The multiple pet feeding platform as recited in claim 19 further comprised of at least one sensor in communication with a smartphone.
